(19) United States
(12) Patent Application Publication
(10) Pub. No.: US 2009/0190044 A1
(43) Pub. Date: Jul. 30, 2009

(54) Mini-projector and detachable signal connector thereof

(75) Inventors: Cheng-Kuo Chu, Tainan County (TW); Chia-Cheng Lai, Tainan County (TW)

Correspondence Address: RABIN & Berdo, PC, 1101 14TH STREET, NW, SUITE 500, WASHINGTON, DC, 20005, US

(73) Assignee: Himax Display, Inc., Tainan County (TW)

(21) Appl. No.: 12/010,353

(22) Filed: Jan. 24, 2008

(51) Int. Cl. H04N 5/64

(52) U.S. Cl. 348/744; 348/E05.137

(57) ABSTRACT

A mini-projector and detachable signal connector thereof are provided. The mini-projector applied to an electronic device comprises a projecting main body and a detachable signal connector. The detachable signal connector has at least a connecting unit. The connecting unit is electrically connected to the electronic device and transmits an image signal from the electronic device to the projecting main body.

### BACKGROUND OF THE INVENTION

1. Field of the Invention

The invention relates in general to a mini-projector, and more particularly to a mini-projector with a detachable signal connector.

2. Description of the Related Art

Humanization technology is identified as a key factor in the present trend of technology. Emphasis of electronic product design is placed on miniaturization, light weight, multifunction and simplification which play important roles in the market. The projector industry is continuously seeking quality improvement, such as better lumen and higher resolution. Furthermore, miniaturization is also an important feature that the projector industry wanting to achieve.

Nowadays, miniaturized projectors are divided into two types, integrated projectors and pocket-size projectors. The integrated projector is to integrate the protector into another electronic device, such as a mobile phone or a laptop computer. The pocket-size projector is to miniaturize the projector as an independent device, such as a palm-size projector. However, in both types of miniaturized projectors, the connection support of the image signal and the connecting module thereof occupy considerable space in the projector, which limits the miniaturization of the projector. Therefore, it is very important to solve the above problem.

### SUMMARY OF THE INVENTION

The invention is directed to a mini-projector and a detachable signal connector thereof. Through the detachable signal connector, the projector is separated into a projecting main body and a signal connector. The projecting main body projects images only according to image signals. Therefore, the miniaturization of the projecting main body is not limited to the connection support of the image signals and the connecting module thereof. The size of the projector can be continuously reduced along with the advance of technology.

According to the present invention, a mini-projector is provided. The mini-projector is applied in an electronic device. The mini-projector includes a projecting main body and a detachable signal connector. The detachable signal connector has at least a connecting unit electrically connected to the electronic device and transmitting an image signal from the electronic device to the projecting main body.

According to the present invention, a detachable signal connector is provided. The signal connector is applied in a mini-projector. The signal connector includes a first video format interface, a transforming unit and a second video format interface. The first image video format interface is for receiving a first video format signal from an electronic device. The transforming unit is electrically connected to the first video format interface and for transforming the first video format signal to a second video format signal. The second video format interface is electrically connected to the transforming unit for outputting the second video format signal to a projecting main body of the mini-projector.

The invention will become apparent from the following detailed description of the preferred but non-limiting embodiments. The following description is made with reference to the accompanying drawings.

### BRIEF DESCRIPTION OF THE DRAWINGS

FIG. 1 is a function block diagram of a mini-projector according to a preferred embodiment of the present invention;

FIG. 2 illustrates a projecting main body directly combined with a signal connector;

FIG. 3 illustrates the projecting main body connecting with the signal connector through an external communication line;

FIG. 4 illustrates the projecting main body connecting with the signal connector through an internal communication line;

FIG. 5 illustrates the projecting main body connecting with the signal connector through wireless communication;

FIG. 6 illustrates the mini-projector with a audio-video decoder; and

FIG. 7 is a function block diagram of the detachable signal connector according to a preferred embodiment of the present invention.

### DETAILED DESCRIPTION OF THE INVENTION

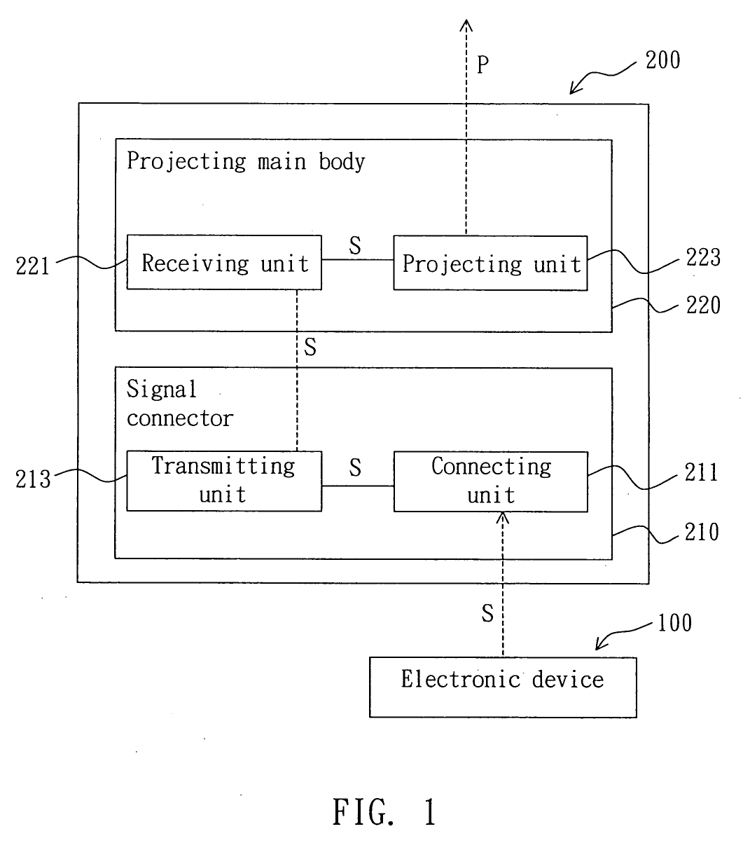

Please referring to FIG. 1, a function block diagram of a mini-projector according to a preferred embodiment of the present invention is illustrated in FIG. 1. As shown in FIG. 1, the mini-projector 200 is applied in an electronic device 100 for example. The electronic device 100 can be any type of portable electronic device, such as a laptop computer, a palm game player, a digital camera, a mobile phone, a personal digital assistant (PDA) or a portable media player. The mini-projector 200 includes a signal connector 210 and a projecting main body 220. The signal connector 210 includes at least a connecting unit 211 and a transmitting unit 213. The projecting main body 220 includes a receiving unit 221 and a projecting unit 223.

In FIG. 1, the connecting unit 211 of the signal connector 210 is electrically connected to the electronic device 100 and for receiving an image signal S from the electronic device 100. The image signal S is transmitted through wired or wireless communication. When the image signal is transmitted through wired communication, the mini-projector 200 further includes a communication line for connecting the connecting unit 211 of the signal connector 210 and the electronic device 100 for transmitting the image signal S.

For example, the electronic device 100 preferably includes at least an image output interface. The image output interface in the wired communication is commonly a high-definition multimedia interface (HDMI), a digital visual interface (DVI), a D-subminiature (D-sub), a VGA interface, an S-terminal, a RCA terminal, a 3RCA terminal or an optical fiber interface. When the image signals are transmitted on wireless communication, the electronic device 100 is commonly configured with a wireless communication module, such as a Bluetooth module, a near field communication (NFC) module or an ultra wide band (UWB) communication module.

Therefore, a corresponding (image) input interface is needed to transmit (image) signals from the electronic device 100 to the connecting unit 211 of the signal connector 210. In the present embodiment, the signal connector 210 can include several connecting units 211 (that is, several different types of image input interfaces). Or, the signal connector 210 includes only one connecting unit 211 (that is, only one image input interface) for connecting with the corresponding (image) output interface of the electronic device 100. The user only has to select the signal connector corresponding to the (image) output interface of the electronic device 100 for transmitting (image) signals.

In the embodiment of the present invention, the connecting unit 211 of the signal connector 210 includes a HDMI, a DVI, a D-sub, a VGA interface, an S terminal interface, a RCA terminal, a 3RCA terminal or an optical fiber interface. However, the present invention is not limited thereto. Or, the connecting unit 211 of the signal connector 210 includes a wireless communication module, such as a Bluetooth module, a NFC module or a UWB module. Similarly, the present invention is not limited thereto.

In FIG. 1, after the connecting unit 211 receives the image signal S of the electronic device 100, the connecting unit 211 transmits the image signal S to the transmitting unit 213. The image signal S received from the electronic device 100 may be not compatible with the projecting main body 220. Therefore, the signal connector 210 may possess the function of converting different image formats to a playable format of the projecting main body 220. However, there are many different ways to convert image formats. The present invention is not limited to a specific method and the device thereof. The device for converting the image formats is not described for simplifying the specification and clarifying the present invention.

Later, the transmitting unit 213 transmits the image signal S to the receiving unit 221 of the projecting main body 220. Thereon, the receiving unit 221 of the projecting main body 220 receives the image signal S, and the projecting unit 223 of the projecting main body 220 projects an image P according to the image signal S.

The signal connector 210 in FIG. 1 is a detachable signal connector. Therefore, signals can be transmitted through wired or wireless communication between the transmitting unit 213 of the signal connector 210 and the receiving unit 221 of the projecting main body 220.

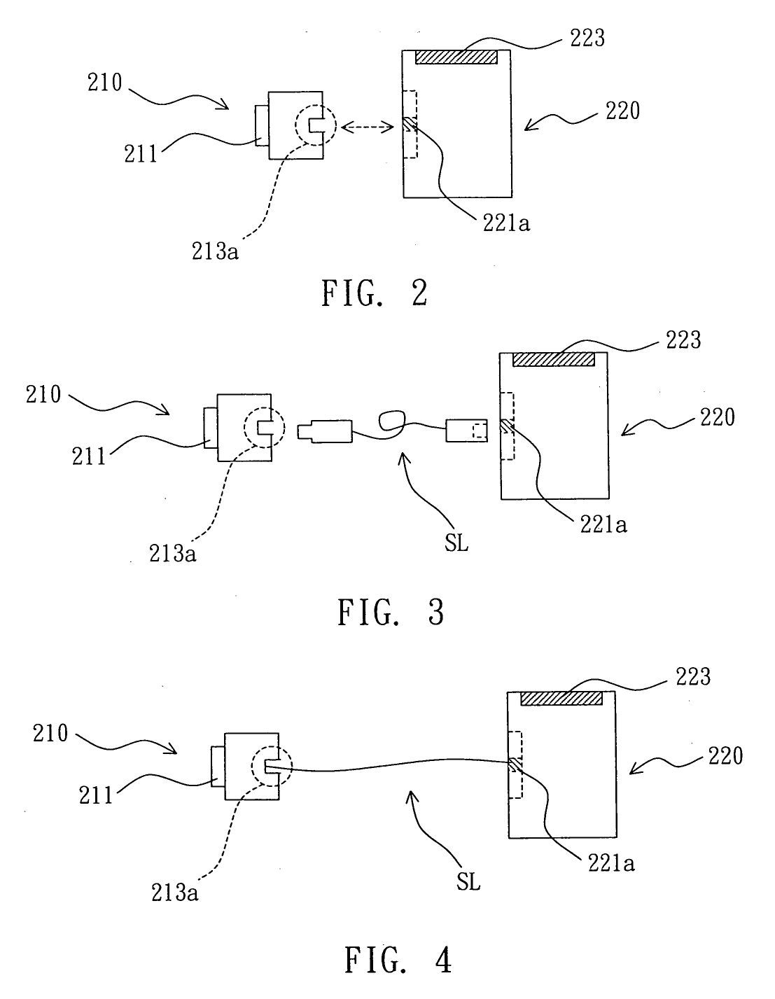

Please refer to both FIG. 1 and FIG. 2. FIG. 2 illustrates the projecting main body directly combined with the signal connector. In an example of the present embodiment, the receiving unit 221 of the projecting main body 220 preferably includes a plug 221a, and the transmitting unit 213 of the signal connector 210 preferably includes a socket 213a. The projecting main body 220 and the signal connector 210 are electrically connected via the combination of the socket 213a and the plug 221a for transmitting signals.

Alternatively, the receiving unit 221 of the projecting main body 220 preferably includes a socket, and the transmitting unit 213 of the signal connector 210 preferably includes a plug. Similarly, the projecting main body 220 and the signal connector 210 are electrically connected via the combination of the socket and the plug.

Please refer to both. FIG. 1 and FIG. 3. FIG. 3 illustrates the projecting main body connecting with the signal connector through an external communication line. In another example of the present embodiment, the mini-projector preferably further includes a communication line SL as shown in FIG. 4. The receiving unit 221 of the projecting main body 220 and the transmitting unit 213 of the signal connector 210 are connected through the communication line SL. Two ends of the communication line SL are respectively a socket and a plug for respectively connecting with the plug 221a of the receiving unit 221 and the socket 213a of the transmitting unit 213. Alternatively, the communication line SL can be for connecting the socket of the receiving unit 221 and the plug of the transmitting unit 213.

Please refer to both FIG. 1 and FIG. 4. FIG. 4 illustrates the projecting main body connecting with the signal connector through an internal communication line. In the present embodiment, FIG. 4 is similar to FIG. 2 and FIG. 3. The difference is in the disposition of the communication line SL. For example, the communication line SL in FIG. 4 is disposed in the signal connector 210 and the projector main body 220 and includes a reel for line storage. When the signal connector 210 and the projecting main body 220 are directly connected, the communication line SL is stored in the signal connector 210 or the projecting main body 220. When the signal connector 210 needs to be separated from the projecting main body 220, only the directly connected structure needs to be detached for pulling out the stored communication line SL. There is no need to perform other connecting steps. In the present embodiment, direct connection is illustrated by using a plug and a socket as an example. However, the present invention is not limited thereto. Direct connection can be achieved through other kinds of connecting structures, such as buckles, locks, or engagement devices.

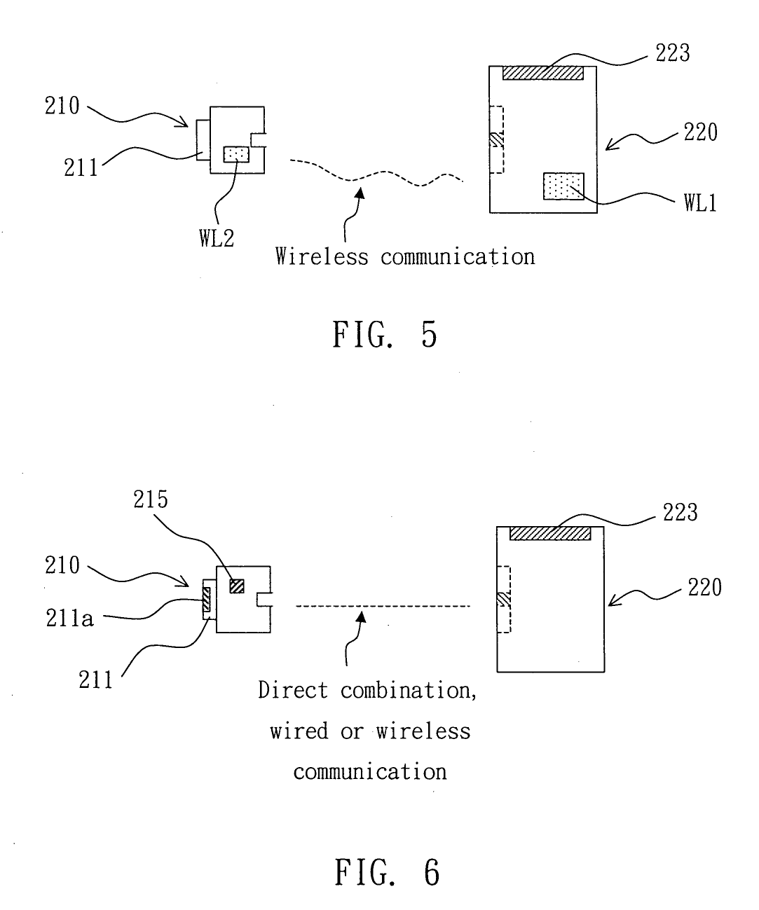

Please refer to both FIG. 1 and FIG. 5. FIG. 5 illustrates the projecting main body connected with the signal connector through wireless communication. In yet another example of the present embodiment, the receiving unit 221 of the projecting main body 220 includes a wireless communication module WL1, and the transmitting unit 213 of the signal connector 210 includes another wireless communication module WL2 as shown in FIG. 5. Signals are transmitted between the projecting main body 220 and the signal connector 210 through the wireless communication modules WL1 and WL2. Preferably, the wireless communication modules WLl and WL2 are Bluetooth modules, near field communication (NFC) modules or ultra wideband (UWB) modules. However, the present invention is not limited thereto. Accordingly, the projecting main body 220 can be disposed freely on any location suitable for projecting images.

Please refer to both FIG. 1 and FIG. 6. FIG. 6 illustrates the mini-projector with an audio-video decoder. In the present embodiment, the signal connector 210 further includes the audio-video decoder 215 for example. The connecting unit 211 of the signal connector 210 preferably includes a memory socket 211a for connecting with a memory card (not shown in the drawings). The audio-video decoder 215 is for reading an audio-video data in the memory card to generate an audio-video signal which is playable by the projecting main body 220. The signal connector 210 connects with the projecting main body 220 through direct combination, wired communication or wireless communication for projecting images.

As stated above, the user can select the signal connector corresponding to the transmission interface of the electronic device 100. Also, the user can place the detachable signal connector and the projecting main body according to the arrangement of the surroundings. Therefore, it is much more convenient to use the mini-projector. Furthermore, through the detachable design, the projecting main body does not need to have the function to convert image formats. Accordingly, the miniaturization of the projecting main body is not limited to the connection support of the image signals. The size of the projector main body can be continuously reduced along with the advance of technology.

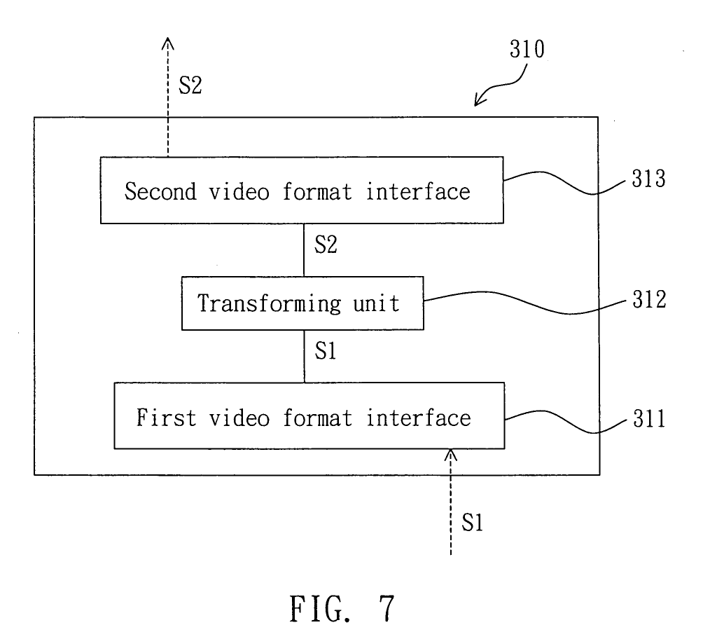

The detachable connector 210 in FIG. 1 is further described with reference to FIG. 7. Please refer to FIG. 7. FIG. 7 is a function block diagram of the detachable signal connector according to a preferred embodiment of the present invention. As shown in FIG. 7, the detachable signal connector 310 includes a first video format interface 311, a transforming unit 312 and a second video format interface 313.

In FIG. 7, the signal connector 310 is similar to the signal connector 210 in FIG. 1. The difference is that the signal connector 310 has the function of converting image formats. The first video format interface 311 corresponds to the connecting unit 211 in FIG. 1. The second video format interface 313 corresponds to the transmitting unit 213 in FIG. 1. The transforming unit 312 is the device to convert video formats, for converting the first video format signal S1 to a second video format signal S2. The first video format signal S1 is the video signal of the electronic device. For example, the first video format signal S1 is a video signal of a HDMI, a DVI, a VGA, a S-terminal, a RCA, a 3RCA, an optical fiber interface, etc. The second video format signal S2 is a video format signal which is playable on the projecting main body 220.

Meanwhile, the signal connector 210 can include several connecting units 211 (that is, different video input interfaces). Or, the signal connector 210 includes only one connecting unit 211 (that is, only one video input interface). Therefore, the signal connector 310 in FIG. 7 can include several first video format interfaces 311 and several transforming units 312 corresponding to the first video format interfaces 311, for converting the first video format signal S1 of the first video format interface to the second video format signal S2.

Besides, the first video format interface 311 is for receiving the first video format signal SI of the electronic device (such as the electronic device 100 in FIG. 1). The signal connection is similar to the connection between the connecting unit 211 and the electronic device 100 in FIG. 1 and therefore not described repeatedly. The second video format interface 313 is electrically connected to the transforming unit 312 for outputting the second video format signal S2 to the projecting main body of the mini-projector (such as the projecting main body 220 of the mini-projector 200 in FIG. 1). The signal connection is similar to the connection between the transmitting unit 213 and the projecting main body 220 in FIG. 1 and therefore not described repeatedly.

Generally speaking, in the above embodiment, the electronic device 100 is connected with the detachable connector 210 or 310 through wired or wireless communication. Then, the video signal S is transmitted to the projecting main body 220 through direct combination, wired communication or wireless communication, for projecting images.

In the mini-projector according to the above embodiment of the present invention, the projector is divided into the projecting main body and the signal connector through the detachable signal connector. The projecting main body projects images only according to the signals and does not need to have the function of converting video formats. Therefore, the miniaturization of the projecting main body is not limited to the connection support of image signals and the connecting module thereof. The size of the projector can be reduced continuously along with the advance of technology. Also, signals can be transmitted between the signal connector and the projecting main body through the communication line or wireless communication module. As a result, practicality and convenience of the mini-projector are increased greatly.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A mini-projector applied in an electronic device, the mini-projector comprising:
a projecting main body; and
a detachable signal connector having at least a connecting unit, the connecting unit being electrically connected to the electronic device and transmitting an image signal from the electronic device to the projecting main body.

2. The mini-projector according to claim 1, wherein the projecting main body comprises a receiving unit and a projecting unit, the receiving unit is for receiving the image signal, and the projecting unit is for projecting the image according to the image signal.

3. The mini-projector according to claim 2, wherein the signal connector further comprises a transmitting unit, which transmits the image signal to the receiving unit of the projecting main body.

4. The mini-projector according to claim 3, wherein the receiving unit of the projecting main body comprises a socket, the transmitting unit of the signal connector comprises a plug, and the projecting main body and the signal connector are electrically connected via the combination of the socket and the plug.

5. The mini-projector according to claim 3, wherein the transmitting unit of the signal connector comprises a socket, the receiving unit of the projecting main body comprises a plug, and the projecting main body and the signal connector are electrically connected via the combination of the socket and the plug.

6. The mini-projector according to claim 3, further comprising:
a communication line, connecting the receiving unit of the projecting main body and the transmitting unit of the signal connector.

7. The mini-projector according to claim 2, wherein the receiving unit of the projecting main body comprises a first wireless communication module, the transmitting unit of the signal connector comprises a second wireless communication module for communicating with the first wireless communication module.

8. The mini-projector according to claim 7, wherein the first wireless communication module and the second wireless communication module are Bluetooth modules, near field communication (NFC) modules or ultra wideband (UWB) communication modules.

9. The mini-projector according to claim 1, wherein the electronic device is a mobile device.

10. The mini-projector according to claim 1, wherein the connecting unit of the signal connector comprises a high-definition multimedia interface (HDMI), a digital visual interface (DVI), a VGA interface, a D-subminiature (D-sub), a S-terminal, a RCA terminal, a 3RCA terminal, or an optical fiber interface.

11. The mini-projector according to claim 1, further comprising:
a communication line, connecting to the connecting unit of the signal connector and the electronic device.

12. The mini-projector according to claim 1, wherein the connecting unit of the signal connector comprises a first wireless communication module, the electronic device comprises a second wireless communication module for communicating with the first wireless communication module.

13. The mini-projector according to claim 12, wherein the first wireless communication module and the second wireless communication module are Bluetooth modules, near field communication (NFC) modules or ultra wideband (UWB) communication modules.

14. The mini-projector according to claim 1, wherein the signal connector further comprises an audio-video decoder, and the connecting unit comprises a memory socket used for connecting with a memory card, so that the audio-video decoder reads an audio-video data in the memory card to generate an audio-video signal.

15. A detachable signal connector applied in a mini-projector, comprising:
a first video format interface, for receiving a first video format signal from an electronic device;
a transforming unit, electrically connecting to the first video format interface and for transforming the first video format signal to a second video format signal; and
a second video format interface, electrically connected to the transforming unit for outputting the second video format signal to a projecting main body of the mini-projector.

16. The signal connector according to claim 15, wherein the projecting main body of the mini-projector comprises a socket, the second video format interface of the signal connector comprises a plug, and the projecting main body and the signal connector are electrically connected via the combination of the socket and the plug.

17. The signal connector according to claim 15, wherein the second video format interface of the signal connector comprises a socket, the projecting main body of the mini-projector comprises a plug, and the projecting main body and the signal connector are electrically connected via the combination of the socket and the plug.

18. The signal connector according to claim 15, further comprising:
a communication line, connecting the projecting main body of the mini-projector and the second video format interface of the signal connector.

19. The signal connector according to claim 15, wherein the projecting main body of the mini-projector comprises a first wireless communication module, the second video format interface of the signal connector comprises a second wireless communication module for communicating with the first wireless communication module.

20. The signal connector according to claim 19, wherein the first wireless communication module and the second wireless communication module are Bluetooth modules, near field communication (NFC) modules or ultra wideband (UWB) communication modules.

21. The signal connector according to claim 15, wherein the first video format interface of the signal connector comprises a high-definition multimedia interface (HDMI), a digital visual interface (DVI), a VGA interface, a D-subminiature (D-sub), a S-terminal, a RCA terminal, a 3RCA terminal, or an optical fiber interface.

22. The signal connector according to claim 21, further comprising:
a communication line, connecting to the first video format interface of the signal connector and the electronic device.

23. The signal connector according to claim 15, wherein the first video format interface of the signal connector comprises a first wireless communication module, the electronic device comprises a second wireless communication module for communicating with the first wireless communication module.

24. The signal connector according to claim 23, wherein the first wireless communication module and the second wireless communication module are Bluetooth modules, near field communication (NFC) modules or ultra wideband (UWB) communication modules.

25. The signal connector according to claim 15, wherein the signal connector further comprises an audio-video decoder, and the connecting unit comprises a memory socket used for connecting with a memory card, so that the audio-video decoder reads an audio-video data in the memory card to generate an audio-video signal.
